(19) United States
(12) Patent Application Publication
(10) Pub. No.: US 2019/0203777 A1
(43) Pub. Date: Jul. 4, 2019

(54) CLUTCH SYSTEM FOR A DRIVETRAIN OF A VEHICLE

(71) Applicant: SCHAEFFLER TECHNOLOGIES AG & CO. KG, Herzogenaurach (DE)

(72) Inventors: Christoph RABER, Ottweiler-Steinbach (DE); Martin CHAMBRION, Erstein (FR); Tim SCHMID, Malsch (DE)

(73) Assignee: Schaeffler Technologies AG & Co. KG, Herzogenaurach (DE)

(21) Appl. No.: 16/312,321

(22) PCT Filed: Jul. 18, 2017
(86) PCT No.: PCT/DE2017/100591

§ 371 Date: Dec. 21, 2018

(30) Foreign Application Priority Data
Jul. 26, 2016 (DE) 10 2016 213 657.7

(51) Int. Cl. F16D 13/56

(52) U.S. Cl. CPC F16D 13/56

(57) ABSTRACT

A clutch system for a vehicle drivetrain includes a first clutch component, a second clutch component, a leaf spring unit, and a second spring element. The first clutch component has first friction elements. The second clutch component has second friction elements connectable to the first friction elements in a torque-transmitting manner. The leaf spring unit is for providing a partial self-intensification and the second spring element is for exerting a static force. The clutch system also has a first hub and a second hub. A one of the second friction elements is rotationally connected to the first hub by the leaf spring unit and an another one of the second friction elements is rotationally coupled directly to the second hub.

### CROSS-REFERENCE TO RELATED APPLICATIONS

This application is the United States National Phase of PCT Appln. No. PCT/DE2017/100591 filed Jul. 18, 2017, which claims priority to German Application No. DE102016213657.7 filed Jul. 26, 2016, the entire disclosures of which are incorporated by reference herein.

### TECHNICAL FIELD

The disclosure relates to a clutch system for a drivetrain of a vehicle, having a first clutch component to introduce torque and a second clutch component to transmit torque. The second clutch component is rotationally decouplable from the first clutch component. First friction elements of the first clutch component and second friction elements of the second clutch component are connectable in a torque-transmitting manner.

### BACKGROUND

A clutch system of this species is known from WO 2014/139526. The latter discloses a clutch system comprising an input side and an output side which are positioned rotatably around an axis, and at least one first friction element and at least one second friction element. The first friction element is torsionally connected to the input side, while the second friction element is torsionally connected to the output side. The first and second friction elements can be brought into frictional engagement by means of a pressing force in order to transmit torque between the input side and the output side. At least one spring means is provided, which intensifies the pressing force of the clutch system.

Such spring means are designed in general as leaf springs, which are able to produce a self-intensification of the pressing force because of their rise angle. The load on the leaf springs is dependent here on the number of friction plates, which transmit their torque to a hub by means of the leaf springs.

DE 10 2016 207 116 proposes to reduce the number of friction surfaces that serve to self-intensify the pressing force. Although this measure greatly increases the robustness of the clutch system, the operating forces and the transmissible traction and drag torques still vary greatly over the life of the clutch system. These variations are mainly the consequence of the high stiffness of the leaf springs which are to create the static pressing force, since the leaf springs have a great weight.

### BRIEF SUMMARY

According to the disclosure, a partial self-intensification of the clutch is possible through one leaf spring unit, while an independent second spring unit exerts a static pressing force. By decoupling the self-intensification by the leaf spring unit and creating the static pressing force by an independent second spring unit, the clutch weight can be reduced, since the number of leaf springs and thus the leaf spring stiffness is reduced, as a partial intensification by the leaf springs of the pressing force created by the second spring unit occurs.

A specified first number of second friction elements of the second clutch component are rotationally connected through the leaf spring unit to a first hub, while a specified second number of second friction elements of the second clutch component are rotationally coupled directly to a second hub. This enables a designed decoupling between the self-intensification and pressing functions.

In one design, the specified first number of second friction elements of the second clutch component each have a raised strap, which meshes with, or is engaged with, the thrust plate of the second clutch component, which is connected to the first hub through the leaf spring unit. Thus a first rotational way is established in which the leaf spring intensifies the pressing force provided by the second spring element.

In one embodiment, the specified second number of second friction elements of the second clutch component are attached to a plate carrier which is connected frictionally to the second hub. The second number of second friction elements are thus attached directly to the second hub, and do not produce a pressing function. This means that the torque which is transmitted by the specified second number of second friction elements is not used for self-intensification of the leaf springs.

In an example embodiment, a rise angle of leaf springs of the leaf spring unit is between 40° and 55°. This relatively large rise angle of the leaf springs reduces the variation of the self-intensification, which prolongs the life of the leaf springs. This design also limits weight of the clutch system, since the leaf springs do not produce any static pressing force here. So it is possible, for example, to use three leaf spring assemblies from at least one single leaf spring unit, which results in a weight saving.

In an example embodiment, the second spring element which produces the static pressing force is designed as a diaphragm spring or compression spring. With the same mass, a diaphragm spring or compression spring is able to store more spring energy than a leaf spring unit. Therefore, the use of diaphragm spring plus leaf spring unit, or of compression springs plus leaf spring unit limits weight.

Advantageously, the diaphragm spring is supported with centering and braced above by a clutch release plate, or support plate, which extends axially. Because of this bracing, the diaphragm spring is able to move elastically out of its extension plane without requiring great force.

In one design, the diaphragm spring is braced underneath by integrated tongues extending radially on the inner and/or outer circumference of the diaphragm spring. Springing of the diaphragm spring axially to the thrust plate is made possible by means of these tongues.

In one embodiment, support pins are used to support the diaphragm spring from the first hub, and support dishes are used to introduce a compression spring force onto the thrust plate; these are cost-effective.

One centrally positioned compression spring or at least two decentrally positioned compression springs are supported axially, depending on the available construction space in the vehicle.

### BRIEF DESCRIPTION OF THE DRAWINGS

The disclosure allows numerous embodiments. Several of these are to be explained in greater detail on the basis of the figures depicted in the drawings.

FIG. 1 shows a first exemplary embodiment of the clutch system.

FIG. 2 shows another exemplary embodiment of the clutch system.

FIG. 3 shows another exemplary embodiment of the clutch system.

FIG. 4 shows another exemplary embodiment of the clutch system.

### DETAILED DESCRIPTION

Like features are identified by the same reference labels.

FIG. 1 shows a first exemplary embodiment of the clutch system in perspective view in cross section. The clutch system 1 has a first clutch component 2, which is connectable to a crankshaft of a combustion engine for an indirect or direct rotary connection. The first clutch component 2 has a sleeve-shaped first plate carrier 3, which has a plurality of friction elements in the form of friction plates 4 on its radial inner surface.

Besides the first clutch component 2, a second clutch component 5 is present in the clutch system 1, which is rotationally decoupled from the first clutch component 2, which has additional friction elements in the form of friction plates 6, 16, or is connected to it non-rotatingly, depending on the position of the clutch system 1.

The first friction plates 4 of the first clutch component 2 and the second friction plates 6, 16 of the second clutch component 5 are arranged axially so that in principle there is always a second friction plate 6, 16 of the second clutch component 5 between each two adjacent first friction plates 4. The friction plates 4, 6, 16 are all movable in the axial direction relative to each other. In the engaged position of the clutch system 1, the first and second friction plates 4, 6, 16 are connected non-rotatingly to each other frictionally by an applied connecting force in the form of the axial pressing force which is produced by a diaphragm spring 11. In the disengaged position of the clutch system 1, on the other hand, the first and second friction plates 4, 6, 16 are positioned forcelessly and thus rotatably relative to each other.

The second clutch component 5 has a thrust plate 7, which is connected non-rotatingly to a leaf spring unit 8. The leaf spring unit 8 is formed for example by a plurality of leaf spring assemblies 9 distributed in the circumferential direction of the clutch system 1, where each leaf spring assembly 9 consists of a plurality of individual leaf springs sandwiched or laid flat on top of one another. The leaf spring assembly 9 is connected at one end non-rotatingly to the thrust plate 7 by a riveted connection. At the other end, each leaf spring assembly 9 is connected to a first hub 10 by another riveted connection. This first hub 10 is connected non-rotatingly to a transmission input shaft (not shown in further detail).

On the thrust plate 6, the diaphragm spring 11 is supported centrally over an axially extending support plate 12, while projections 13 of the support plate 12 mesh with the diaphragm spring 11, which spreads them radially. A bottom support of the diaphragm spring 11 is accomplished by integrated tongues 14 formed on the inner and outer circumference of the diaphragm spring 11, which are positioned outside the force rim of the diaphragm spring 11. This special type of base makes it possible to actuate the diaphragm spring 11 beyond the planned position, which contributes to the springy support of the diaphragm spring 12.

Link plates 15 of a first number of friction plates 6 of the second clutch component 5 mesh with the thrust plate 7 from beneath. These link plates 15 are bent axially opposite the radially extending friction plates 6, and make it possible to center the friction plates 6 relative to the thrust plate 7 and realize the transport of the torque transmitted by the first clutch component. The leaf spring unit 8 passes the torque absorbed from the second clutch component 5 on to the transmission input shafts through three first friction surfaces of the respective friction plate 6, which brings about a self-intensification of the pressing force produced by the diaphragm spring 11. Since the torque is transmitted to the leaf spring unit 8 by a limited number of friction plates 6 of the clutch component 5, the leaf spring unit 8 thus carries out a partial self-intensification of the pressing force of the diaphragm spring 11.

The remaining friction plates 16 of the second clutch component 5 are connected to a second plate carrier 17. The second plate carrier 17 is riveted to a second hub 18, the second hub 18 also being connected to the transmission input shaft. This leads to a direct coupling of the torque transmitted by the first clutch component 5 to the transmission input shaft.

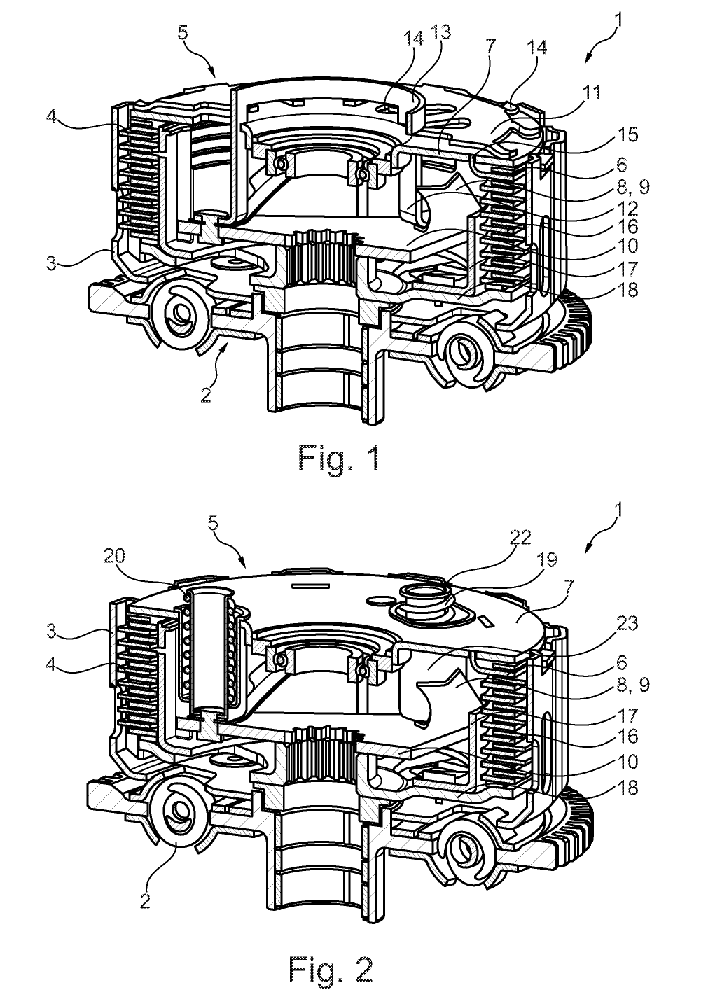

FIG. 2 shows another exemplary embodiment of the clutch system 1, which differs from FIG. 1 in that instead of the diaphragm spring 11 three centrally supported compression springs 19, 20, are used, only two of which are shown in the half section of the clutch system 1 depicted in FIG. 2. In this case, the static pressing force is produced by these compression springs 19, 20. These compression springs 19, 20 are supported by means of support pins 22 and support dishes 23. The support pins 22 enable the compression spring force to be supported by the first hub 10. The support dishes 23 enable the introduction of the compression spring force to the thrust plate 7.

In both FIG. 1 and FIG. 2, the partial self-intensification is produced by three friction surfaces of the first and second friction plates 4, 6.

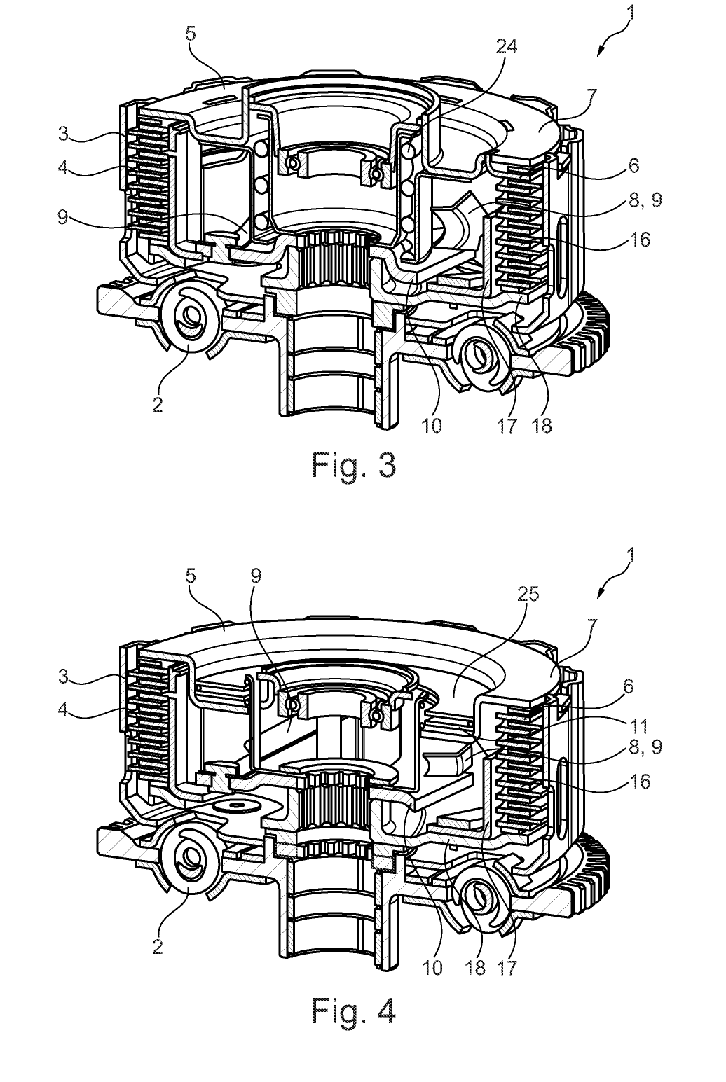

FIG. 3 shows another exemplary embodiment of the clutch system, which can be used in particular whenever radial construction space is tight. In order to configure the construction space of the clutch system 1 as small as possible, the compression spring is designed as a central construction spring 24.

FIG. 4 shows another exemplary embodiment of the clutch system, in which two diaphragm springs 11, 25 are located one above the other. With these two stacked diaphragm springs 11, 25, the characteristic curve of the clutch is changed so that a large force plateau is produced for actuation of the clutch, which contributes to an increase in the life of the clutch system. In addition, in this embodiment five friction surfaces of clutch plates 6 are provided for the partial self-intensification of the pressing force.

The proposed solution shows a clutch system 1 that is in a more stable and weight-optimized package, containing a leaf spring unit 8. That improves the variation in performance of the clutch over its lifetime, since less torque needs to be transmitted by means of the leaf spring unit 8; this increases the safety against buckling of the leaf springs of the leaf spring unit 8 and their tendency to settle over the lifetime of the clutch system 1. Since the static pressing force is produced with an additional spring unit, which is able to store more spring energy for a similar mass than the leaf spring unit 8, this contributes to a weight saving. Furthermore, the energy to actuate the clutch system 1 is reduced through the use of compression springs or diaphragm springs.

### REFERENCE LABELS

1 clutch system
2 first clutch component
3 plate carrier
4 friction plates
5 second clutch component
6 friction plates
7 thrust plate
8 leaf spring unit
9 leaf spring assembly
10 hub
11 diaphragm spring
12 support plate
13 protrusion
14 tongue
15 strap
16 friction plate
17 plate carrier
18 hub
19 compression spring
20 compression spring
22 support pin
23 support dish
24 compression spring
25 diaphragm spring

1.-10. (canceled)

11. A clutch system for a vehicle drivetrain comprising:
a first clutch component comprising first friction elements;
a second clutch component comprising second friction elements connectable to the first friction elements in a torque-transmitting manner;
a leaf spring unit for providing a partial self-intensification; and,
a second spring element for exerting a static force.

12. The clutch system of claim 11 further comprising:
a first hub; and,
a second hub, wherein:
a one of the second friction elements is rotationally connected to the first hub by the leaf spring unit; and,
an another one of the second friction elements is rotationally coupled directly to the second hub.

13. The clutch system of claim 12 wherein:
the one of the second friction elements comprises a raised strap;
the second clutch component comprises a thrust plate;
the raised strap is engaged with the thrust plate; and,
the thrust plate is connected to the first hub through the leaf spring unit.

14. The clutch system of claim 12 further comprising a second plate carrier frictionally connected to the second hub, wherein the another one of the second friction elements is attached to the second plate carrier.

15. The clutch system of claim 11, wherein:
the leaf spring unit comprises a leaf spring with a rise angle; and,
the rise angle is between 40° and 55°.

16. The clutch system of claim 11 wherein the second spring element is a diaphragm spring or compression spring.

17. The clutch system of claim 16, further comprising an axially extending support plate, wherein the second spring element is a diaphragm spring supported with centering and braced above by the axially extending support plate.

18. The clutch system of claim 17, wherein:
the diaphragm spring comprises a radially inner circumference and a radially outer circumference;
the radially inner circumference or the radially outer circumference comprises a plurality of radially extending integral tongues; and,
the diaphragm spring is braced underneath by the plurality of radially extending integrated tongues.

19. The clutch system of claim 16 wherein the second spring element is a compression spring, the clutch system further comprising:
a first hub;
a release plate;
a plurality of support pins to support the compression spring from the first hub; and,
a plurality of support dishes to introduce a compression spring force to the release plate.

20. The clutch system of claim 16 wherein:
the second spring element is an axially supported, centrally positioned compression spring; or,
the second spring element is at least two axially supported, decentrally positioned compression springs.

21. A clutch system for a vehicle drivetrain comprising:
a first plate carrier arranged for driving engagement with an engine crankshaft;
a first plurality of friction plates drivingly engaged with the first plate carrier;
a second plate carrier;
a second plurality of friction plates, interlaced with the first plurality of friction plates and drivingly engaged with the second plate carrier;
a first hub arranged for driving engagement with a transmission input shaft;
a second hub drivingly engaged with the second plate carrier and arranged for driving engagement with the transmission input shaft;
a plurality of leaf springs;
a thrust plate connected to the first hub by the plurality of leaf springs; and,
a spring unit for exerting a pressing force on the thrust plate to compress the first plurality of friction plates with the second plurality of friction plates to transmit a torque from the engine crankshaft to the transmission input shaft.

22. The clutch system of claim 21 further comprising:
a link plate drivingly engaged with the thrust plate, wherein a one of the first plurality of friction plates is disposed axially between the thrust plate and the link plate.

23. The clutch system of claim 21 further comprising a support plate fixed to the first hub, wherein the spring unit is a diaphragm spring comprising radially inwardly extending tongues axially retained by the support plate.

24. The clutch system of claim 23 wherein the diaphragm spring further comprises radially outwardly extending tongues contacting the thrust plate.

25. The clutch system of claim 21 wherein the spring unit is a plurality of compression springs.

26. The clutch system of claim 25 further comprising:
a plurality of support pins fixed to the first hub; and,
a plurality of support dishes installed in the thrust plate, wherein each of the plurality of compression springs is axially retained between a one of the plurality of support pins and a one of the plurality of support dishes.

27. The clutch system of claim 21 wherein each of the plurality of leaf springs comprises a rise angle between 40 degrees and 55 degrees.
